(19) United States
(12) Patent Application Publication
(10) Pub. No.: US 2022/0015405 A1
(43) Pub. Date: Jan. 20, 2022

(54) CONDENSATION SYSTEM AND METHOD

(71) Applicant: Jocelyn Dumont, Drummondville (CA)

(72) Inventor: Jocelyn Dumont, Drummondville (CA)

(21) Appl. No.: 17/305,766

(22) Filed: Jul. 14, 2021

Related U.S. Application Data
(60) Provisional application No. 63/051,613, filed on Jul. 14, 2020.

(51) Int. Cl. A23L 29/30; A23L 5/20

(52) U.S. Cl. CPC A23L 29/30; A23L 5/21

(57) ABSTRACT

A system and method for depressurizing a boiler for the production of sap syrup from sap, including maple sap comprising a condenser and one or more pumps. In a first step, the vapour generated by the boiler is condensed into condensate thereby reducing the energy required to boil the maple sap. A second pump may additionally be configured to displace the vapour which has not been condensed thereby allowing a greater depressurization and an additional energy saving.

### CROSS-REFERENCE TO RELATED APPLICATIONS

The present patent application claims the benefits of priority of U.S. Patent Application No. 63/051,613, entitled “CONDENSATION SYSTEM AND METHOD”, and filed at the United States Patent and Trademark Office on Jul. 14, 2020, the content of which is incorporated herein by reference.

### FIELD OF THE INVENTION

The present invention generally relates to systems and methods for evaporating water from a diluted liquid. More particularly, the present invention generally relates to systems and methods for depressurizing a boiler for evaporating water from maple sap.

### BACKGROUND OF THE INVENTION

The production of maple syrup is an energy intensive process as large quantities of maple sap must be boiled in order to remove water in excess thereby producing concentrate of maple sap, also referred to as maple syrup when a desired concentration of maple sugar is reached. For example, 30 to 45 L of maple sap is typically required to produce 1 L of maple syrup.

It is known in the art that the boiling point of a liquid varies upon the surrounding environmental pressure with the boiling temperature (and therefore the energy necessary to reach said boiling temperature) decreasing as the atmospheric pressure decreases. However, conventional boilers experience an increase in pressure as steam is generated within a confined space of the boiler thereby increasing the energy necessary to achieve the desired boil.

Accordingly, there is a need for a system and method for reducing the atmospheric pressure within a boiler and thus reduce the cost of producing maple syrup.

### SUMMARY OF THE INVENTION

The aforesaid and other objectives of the present invention are realized by generally providing a system and method to reduce the pressure of the water vapour within the boiler in order to increase the energy efficiency of the maple syrup production. The reduction in energy required for the production will be the difference between the reduced energy required for boiling of the maple sap and the energy required to achieve the depressurization of the water vapour in the boiler.

This is achieved by both i) condensing a portion of the water vapour within a boiler system comprising a pan in which the maple sap is placed and a hermetically sealed enclosure which is attached in an airtight manner to the pan, and ii) removing the remaining water vapour from the enclosure by the use of a vacuum pump.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a side schematic elevation view of an embodiment of a boiler for the production of syrup in accordance with the principles of the present invention.

FIG. 2 is a side schematic elevation view of a hermetically enclosed structure and collection reservoir of the boiler of FIG. 1.

FIG. 3 is a side schematic elevation view of another embodiment of a boiler for the production of syrup in accordance with the principles of the present invention.

### DETAILED DESCRIPTION OF THE PREFERRED EMBODIMENT

A novel condensation system and method will be described hereinafter. Although the invention is described in terms of specific illustrative embodiments, it is to be understood that the embodiments described herein are by way of example only and that the scope of the invention is not intended to be limited thereby.

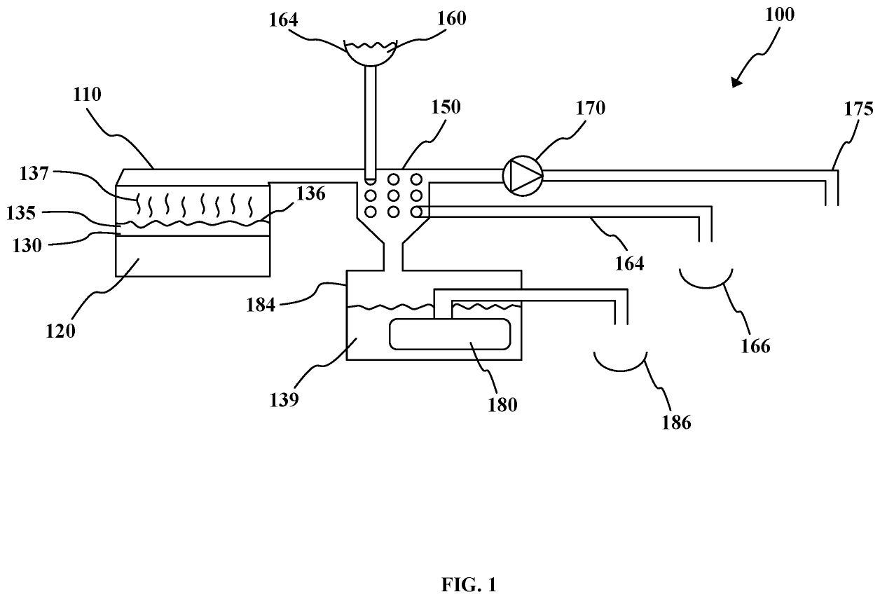

The production of syrup can be achieved by boiling sap in a boiler 100 comprising an enclosed structure 110. The enclosed structure may comprise a cuboid, a dome, a cylinder, a pyramid or any other suitable shape. Referring to FIG. 1 and as explained further below, the boiler 100 is configured to reduce the water vapour pressure within the enclosed structure 110. To that end, the enclosed structure 110 needs to be hermetically sealed with respect to the external surrounding atmosphere.

The boiler 100 may further comprise a heater 120 configured to transfer energy from a heat source to a pan 130. The sap, sap concentrate or any other suitable liquid mixture 135 for the production of syrup is introduced to the pan 130 from a fluid source by any known means. The liquid 135 may comprise any suitable fluid produced by a plant including, but not limited to, maple sap, birch sap, palm tree sap, agave nectar, and cane juice.

In a preferred embodiment, the heater 120 is configured to maintain an energy transfer rate suitable to reach a boiling temperature of the liquid 135 within the pan 130. The heater 120 may transfer energy from an energy source such as, but not limited to, wood, pellets, oil, compressed steam, natural gas, propane or electricity.

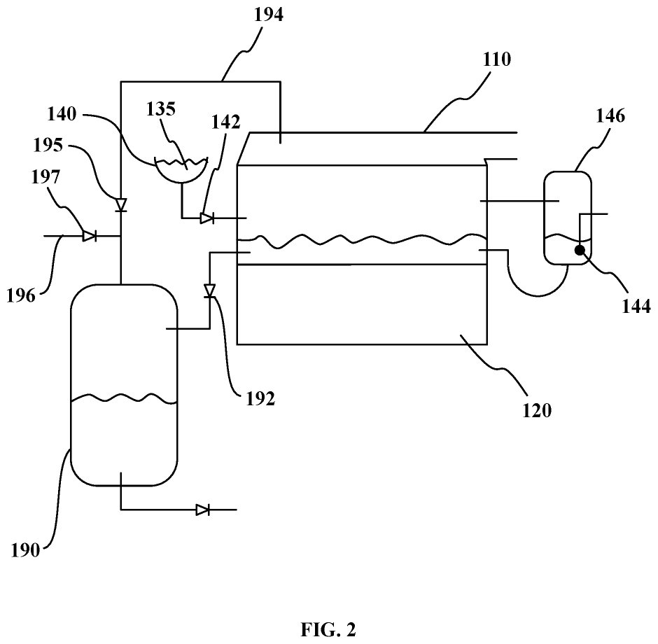

Referring now to FIG. 2, the boiler 100 comprises a reservoir 140 adapted to store and release the liquid 135 into the enclosed structure 110 and pan 130. The liquid 135 may be introduced onto the pan 130 by means of an injection valve 142. In order to maintain a reduced pressure within the enclosed structure 110, the injection valve 142 may comprise a check valve or one-way valve regulated to only allow a desirable liquid flow rate.

The boiler 100 may further comprise a volume probe 144 adapted to determine the level of liquid 135 contained within the pan 130. To that end, the injection valve 142 may be actuated to allow a flow of liquid 135 into the enclosed structure 110 when the volume of liquid 135 falls below a predetermined level. In certain embodiments, the boiler 100 may comprise an external chamber 146 in fluid communication with the enclosed structure 110 and adapted to receive the volume probe 144. Configured in this manner, the volume probe 144 may provide a more accurate reading of the volume of liquid 135 unencumbered by possible interference generated by the boiling of said liquid 135.

In certain embodiments, the liquid 135 may have undergone reverse osmosis such as to remove or reduce its water content prior to being injected into the enclosed structure 110. Preferably, 75% to 90% of the water may be removed from the liquid 135 thereby potentially reducing the energy consumption of the boiler 100 and exposure of the liquid 135 to high temperatures.

Referring again to FIG. 1, the enclosed structure 110 is configured to channel steam 137 generated by the boiling of the liquid 135 contained within the pan 130. It may be appreciated that the pressure within the enclosed structure 110 increases as steam 137 is generated by the boiling of the liquid 135.

As specified earlier, the boiler 100 should be configured to reduce the pressure of the steam 137 within the enclosed structure 110. This may be achieved by using a condenser 150 configured to reduce the temperature of the steam 137 and preferably condense the steam 137 into water. In order to reduce the temperature of the steam 137, the condenser 150 may passively transfer heat to a coolant 160 which can be sap, partially concentrated sap, water, air or other known coolants. It may be appreciated that the temperature of the coolant 160 must be below that of the steam 137 in order to efficiently transfer heat between the fluids. In a preferred embodiment, the coolant 160 is a liquid having a high thermal capacity, low viscosity and which is chemically inert.

The coolant 160 may be supplied to the condenser 150 from a coolant source 164. In certain embodiments, the coolant 160 may be water while the coolant source 164 may comprise a natural source such as a lake, a stream or any other still or flowing body of water. In other embodiments, the coolant source 164 may comprise a manufactured container or reservoir configured to supply the coolant 160 to the condenser 150.

Preferably, the condenser 150 will cool the steam 137 beyond its saturation temperature thereby causing a phase change into liquid form (i.e. water). As such, the condenser 150 may condense the steam 137 into condensate 139.

In certain operating environments, it may be preferable to not freely drain the coolant 160 having passed through the condenser 150 into the environment. To that end, the coolant 160 having passed through the condenser 150 may be conveyed through an exhaust conduit 164 and collected in a collector 166. In certain embodiments, the coolant 160 may be recirculated from the collector 166 to the coolant source 164 after having been cooled to a desirable temperature. In other embodiments still, the coolant 160 may comprise a two-phase gas circulating between the collector 166 and the coolant source 164 by means of a compressor (not shown).

In other embodiments still, the coolant 160 may comprise sap or a sap concentrate. Accordingly, the sap having already been pre-heated through the condenser 150 may be sent to the pan 130 to be boiled thereby further reducing the energy necessary to boil said sap or sap concentrate.

The boiler 100 may further comprise one or more pumps configured to remove fluids from the enclosed structure 110 and the condenser 150. The pumps may be liquid ring vacuum pumps, positive displacement pumps, impulse pumps, velocity pumps, any other pump suitable for displacing low-pressure fluids without loss of vacuum or any combination thereof.

According to the present embodiment, the boiler 100 comprises a first pump 170 configured to displace steam 137 which has not been condensed within the condenser 150. In a preferred embodiment, the pump 170 is a vacuum pump such as a liquid ring vacuum pump allowing a greater depressurization of the enclosed structure 110. In certain embodiments, the steam 137 which has been displaced by the pump 170 may be expelled from the boiler 100 via an exhaust pipe 175 into the surrounding atmosphere. Understandably, in other embodiments, the exhaust pipe 175 may be fluidly connected to a collection tank (not shown) for collection of the steam 137. As an example, a 5 HP rated vacuum pump may be adequate for a relatively small system.

In certain embodiments, the enclosed structure 110 and/or pan 130 may comprise an air intake (not shown) adapted to introduce air therein. The introduction of air through the air intake may promote air circulation within the boiler 100 thereby facilitating the displacement of the steam 137 by the pump 170 and increasing the efficiency of the boiler 100. An air intake disposed within the pan 130 may be located beneath a surface 136 of the liquid 135 in the pan 130 or in proximity of the surface 136. In certain embodiments, air being introduced through the air intake may be pre-heated.

The boiler 100 may additionally comprise a second pump 180 configured to pump the condensate 139 generated by the condenser 150. Prior to being pumped, the condensate 139 may be conveyed from the condenser into a drainage tank 184 by means of a check valve or one-way valve (not shown). The one-way valve may be configured to prevent fluids from re-entering the enclosed structure 110.

While the condensate 139 may be released into the surrounding environment, ecological considerations or environmental regulations may encourage its collection for appropriate disposal. Accordingly, a reservoir 186 may be installed to collect the condensate 139 displaced by the second pump 180.

It may be appreciated that the condenser 150 and the operation of the first and second pumps 170, 180 may displace a substantial portion of the fluids contained within the enclosed structure 110, namely the steam 137 and the condensate 139. The pressure within the enclosed structure 110 will therefore be reduced thereby lowering the boiling point and vapor pressure of the liquid 135 which will reduce the energy required to boil the liquid 135.

Referring again to FIG. 2, the boiled liquid 135 may be collected in a collection reservoir 190. In certain embodiments, the liquid 135 may be conveyed from the enclosed structure 110 to the collection reservoir 190 via an output valve 192 when both volumes are depressurized such as to prevent fluids from re-entering the enclosed structure 110 from the collection reservoir 190. The collection reservoir 190 may be depressurized using any suitable means. In certain embodiments, the collection reservoir 190 may be depressurized by fluidly connecting it to the vacuum pump 170. Accordingly, a depressurized conduit 194 comprising a check valve 195 may fluidly connect the collection reservoir 190 and the enclosed structure 110 depressurized by the vacuum pump 170.

It may be appreciated that collection of the liquid 135 may be best achieved when the pressure within the collection reservoir 190 is greater than or equal to the atmospheric pressure. The collection reservoir 190 may therefore be fluidly connected to an atmospheric or pressurized conduit 196 comprising a check valve 197 adapted to selectively pressurize said collection reservoir 190 such as to allow collection of the liquid 135 contained therein. Understandably, the output valve 192 and check valve 195 are preferably closed when pressurizing the reservoir 190.

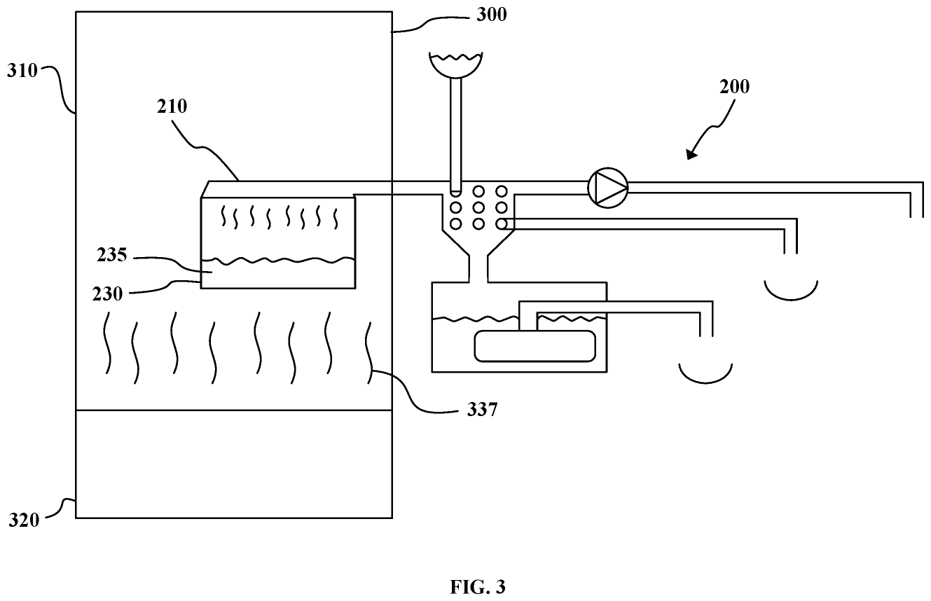

In another embodiment of the present invention and referring now to FIG. 3, a pan 230 of a boiler 200 may be disposed within a traditional enclosure 310 of a traditional boiler or evaporator 300 for the production of syrup having a heat source 320. To that end, the boiler 100 may no longer comprise a heater 120 to provide a heat source for the heating of the liquid 235. Instead, the pan 230 of the boiler 200 may be heated by ambient steam 337 generated by the traditional boiler or evaporator 300. Configured in this manner, the boiler 200 may provide an additional production line to a traditional syrup boiler or evaporator 300 while using energy typically discarded in the form of exhaust steam.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A system for the reducing the energy consumption of a boiler, the system comprising:
a) a hermetically sealed enclosure configured to receive vapor produced by the boiler;
b) a condenser configured to cool the vapor into a condensate; and
c) a first pump configured to displace uncondensed vapor out of the enclosure.

2) The system of claim 1 further comprising a heating source for producing the vapour from a liquid.

3) The system of claim 1 further comprising a second pump configured to displace the condensate out of the condenser.

4) The system of claim 1 further comprising a second pump configured to displace the condensate into a coolant chamber of the condenser.

5) The system of claim 1, wherein the first pump is a liquid ring vacuum pump.

6) The system of claim 2 further comprising an injection valve configured to selectively inject the liquid into the boiler.

7) The system of claim 6 further comprising a sensor configured to detect a volume of the liquid within the boiler.

8) The system of claim 6, wherein the injection valve is a check valve.

9) The system of claim 2 further comprising a hermetically sealed reservoir configured to receive the boiled liquid.

10) The system of claim 9, wherein the reservoir is fluidly connected to the first pump.

11) The system of claim 10 further comprising a first check valve for selectively fluidly isolating the reservoir from the first pump.

12) The system of claim 11 further comprising a second check valve for selectively fluidly connecting the reservoir to a pressurized volume, the pressurized volume having a pressure being greater than the pressure within the enclosure.

13) A method of depressurizing a boiler producing steam from a liquid, the method comprising:
a) condensing a first portion of the steam;
b) displacing a second portion of the uncondensed steam out of the boiler;
c) displacing the condensed steam out of the boiler.

14) The method of claim 13, wherein condensing a first portion of the steam comprises passing the steam through a condenser.

15) The method of claim 14, wherein the liquid is sap and further comprising displacing the sap through a coolant chamber of the condenser.

16) The method of claim 15 further comprising displacing the condensed steam through a coolant chamber of the condenser.

17) The method of claim 13 further comprising conveying the liquid of the boiler into a hermetically sealed reservoir.

18) The method of claim 17 further comprising selectively pressurizing and depressurizing the reservoir.

19) The method of claim 13 further comprising detecting the volume of liquid within the boiler.

20) The method of claim of claim 13 further comprising lowering a boiling point of the liquid below 45° C.
